(19) United States
(12) Patent Application Publication
(10) Pub. No.: US 2026/0321505 A1
(43) Pub. Date: Oct. 15, 2026

(54) VOLTAGE DIVIDING CAPACITOR

(71) Applicant: TDK Corporation, Tokyo (JP)

(72) Inventors: Hitoshi SAITA, Tokyo (JP); Rieki KAZAWA, Tokyo (JP)

(21) Appl. No.: 19/156,949

(22) PCT Filed: Feb. 20, 2024
(86) PCT No.: PCT/JP2024/005975

§ 371 Date: Aug. 15, 2025

Related U.S. Application Data
(60) Provisional application No. 63/447,955, filed on Feb. 24, 2023.

(51) Int. Cl. H01G 4/30; H01G 4/14; H01G 4/232; H01G 4/38

(52) U.S. Cl. CPC H01G 4/30; H01G 4/14; H01G 4/232; H01G 4/38

(57) ABSTRACT

To provide a voltage dividing capacitor capable of dividing an input voltage. A voltage dividing capacitor includes capacitors, an insulating resin layer positioned between a lower electrode layer of the capacitor and an upper electrode layer of the capacitor, and via conductors VA to VC penetrating the capacitor, insulating resin layer, and capacitor. The via conductor VB is connected to an upper electrode layer of the capacitor, the via conductor VA is connected to a lower electrode layer of the capacitor, and the via conductor VC is connected to a lower electrode layer of the capacitor and an upper electrode layer of the capacitor.

### CROSS-REFERENCE TO RELATED APPLICATIONS

This application is the U.S. National Phase under 35 U.S.C. § 371 of International Application No. PCT/JP2024/005975, filed on Feb. 20, 2024, which claims the benefit of priority to U.S. Provisional Patent Application No. 63/447,955 filed on Feb. 24, 2023, the entire contents of each of which are hereby incorporated by reference.

### TECHNICAL FIELD

The present disclosure relates to a voltage dividing capacitor.

### BACKGROUND ART

Patent Document 1 discloses a laminated thin film capacitor obtained by laminating a plurality of thin film capacitors.

### CITATION LIST

### Patent Document

[Patent Document 1] JP 2019-140312A

### DISCLOSURE OF THE INVENTION

### Problem to be Solved by the Invention

The thin film capacitor described in Patent Document 1 is a two-terminal type thin film capacitor including a plurality of parallel-connected thin film capacitors.

The present disclosure describes a voltage dividing capacitor capable of dividing an input voltage.

### Means for Solving the Problem

A voltage dividing capacitor according to an aspect of the present disclosure includes: a first capacitor having a first upper electrode layer, a first lower electrode layer, and a first dielectric layer positioned between the first upper electrode layer and the first lower electrode layer; a second capacitor having a second upper electrode layer, a second lower electrode layer, and a second dielectric layer positioned between the second upper electrode layer and the second lower electrode layer; a first insulating resin layer positioned between the first lower electrode layer and the second upper electrode layer; and first, second, and third via conductors penetrating the first capacitor, the first insulating resin layer and the second capacitor, wherein the first via conductor is connected to the first upper electrode layer, the second via conductor is connected to the second lower electrode layer, and the third via conductor is connected to the first lower electrode layer and second upper electrode layer.

A voltage dividing capacitor according to another aspect of the present disclosure includes: a first capacitor having a first upper electrode layer, a first lower electrode layer, and a first dielectric layer positioned between the first upper electrode layer and the first lower electrode layer; a second capacitor having a second upper electrode layer, a second lower electrode layer, and a second dielectric layer positioned between the second upper electrode layer and the second lower electrode layer; a third capacitor having a third upper electrode layer, a third lower electrode layer, and a third dielectric layer positioned between the third upper electrode layer and the third lower electrode layer; a first insulating resin layer positioned between the first lower electrode layer and the second upper electrode layer; a second insulating resin layer positioned between the second lower electrode layer and the third upper electrode layer; and first, second, third, and fourth via conductors penetrating the first capacitor, the first insulating resin layer, the second capacitor, the second insulating resin layer, and the third capacitor, wherein the first via conductor is connected to the first upper electrode layer, the second via conductor is connected to the third lower electrode layer, the third via conductor is connected to the second lower electrode layer and third upper electrode layer, and the fourth via conductor is connected to the first lower electrode layer and second upper electrode layer.

A voltage dividing capacitor according to still another aspect of the present disclosure includes: a first capacitor having a first upper electrode layer, a first lower electrode layer, and a first dielectric layer positioned between the first upper electrode layer and the first lower electrode layer; a second capacitor having a second upper electrode layer, a second lower electrode layer, and a second dielectric layer positioned between the second upper electrode layer and the second lower electrode layer; a third capacitor having a third upper electrode layer, a third lower electrode layer, and a third dielectric layer positioned between the third upper electrode layer and the third lower electrode layer; a fourth capacitor having a fourth upper electrode layer, a fourth lower electrode layer, and a fourth dielectric layer positioned between the fourth upper electrode layer and the fourth lower electrode layer; a fifth capacitor having a fifth upper electrode layer, a fifth lower electrode layer, and a fifth dielectric layer positioned between the fifth upper electrode layer and the fifth lower electrode layer; a sixth capacitor having a sixth upper electrode layer, a sixth lower electrode layer, and a sixth dielectric layer positioned between the sixth upper electrode layer and the sixth lower electrode layer; a first insulating resin layer positioned between the first lower electrode layer and the second upper electrode layer; a second insulating resin layer positioned between the second lower electrode layer and the third upper electrode layer; a third insulating resin layer positioned between the third lower electrode layer and the fourth upper electrode layer; a fourth insulating resin layer positioned between the fourth lower electrode layer and the fifth upper electrode layer; a fifth insulating resin layer positioned between the fifth lower electrode layer and the sixth upper electrode layer; and first, second, third, fourth, fifth, and sixth via conductors penetrating the first capacitor, the first insulating resin layer, the second capacitor, the second insulating resin layer, the third capacitor, the third insulating resin layer, the fourth capacitor, the fourth insulating resin layer, the fifth capacitor, the fifth insulating resin layer, and the sixth capacitor, wherein the first via conductor is connected to the first upper electrode layer, the second via conductor is connected to the fifth lower electrode layer and sixth upper electrode layer, the third via conductor is connected to the fourth lower electrode layer and fifth upper electrode layer, the fourth via conductor is connected to the first lower electrode layer and second upper electrode layer, the fifth via conductor is connected to the second lower electrode layer, third upper electrode layer, and sixth lower electrode layer, and the sixth via conductor is connected to the third lower electrode layer and fourth upper electrode layer.

### Advantageous Effects of the Invention

According to the present disclosure, a voltage dividing capacitor capable of dividing an input voltage is provided.

### BRIEF DESCRIPTION OF THE DRAWINGS

FIG. 1A is a schematic cross-sectional view illustrating a voltage dividing capacitor 100 according to a first embodiment of the technology described herein. FIG. 1B is a schematic top view of the voltage dividing capacitor 100.

FIG. 2A is a schematic plan view of the upper electrode layer 111. FIG. 2B is a schematic plan view of the lower electrode layer 112. FIG. 2C is a schematic plan view of the upper electrode layer 121. FIG. 2D is a schematic plan view of the lower electrode layer 122.

FIG. 3 is an equivalent circuit diagram of the voltage dividing capacitor 100.

FIG. 4 is a schematic cross-sectional view illustrating a voltage dividing capacitor 101 according to a first modification.

FIG. 5 is a schematic cross-sectional view illustrating a voltage dividing capacitor 102 according to a second modification.

FIG. 6 is a schematic cross-sectional view illustrating a voltage dividing capacitor 103 according to a third modification.

FIG. 7A is a schematic cross-sectional view illustrating a voltage dividing capacitor 200 according to a second embodiment of the technology described herein. FIG. 7B is a schematic top view of the voltage dividing capacitor 200.

FIG. 8A is a schematic plan view of the upper electrode layer 211. FIG. 8B is a schematic plan view of the lower electrode layer 212. FIG. 8C is a schematic plan view of the upper electrode layer 221. FIG. 8D is a schematic plan view of the lower electrode layer 222. FIG. 8E is a schematic plan view of the upper electrode layer 231. FIG. 8F is a schematic plan view of the lower electrode layer 232. FIG. 8G is a schematic plan view of the upper electrode layer 241. FIG. 8H is a schematic plan view of the lower electrode layer 242.

FIG. 9 is an equivalent circuit diagram of the voltage dividing capacitor 200.

FIG. 10 is a schematic cross-sectional view illustrating a voltage dividing capacitor 300 according to a third embodiment of the technology described herein.

FIG. 11 is an equivalent circuit diagram of the voltage dividing capacitor 300.

FIG. 12A is a schematic cross-sectional view illustrating a voltage dividing capacitor 400 according to a fourth embodiment of the technology described herein. FIG. 12B is a schematic top view of the voltage dividing capacitor 400.

FIG. 13 is an equivalent circuit diagram of the voltage dividing capacitor 400.

FIG. 14 is a schematic cross-sectional view illustrating a voltage dividing capacitor 500 according to a fifth embodiment of the technology described herein.

FIG. 15 is an equivalent circuit diagram of the voltage dividing capacitor 500.

### MODE FOR CARRYING OUT THE INVENTION

Hereinafter, preferred embodiments of the present invention will be described in detail with reference to the accompanying drawings.

### First Embodiment

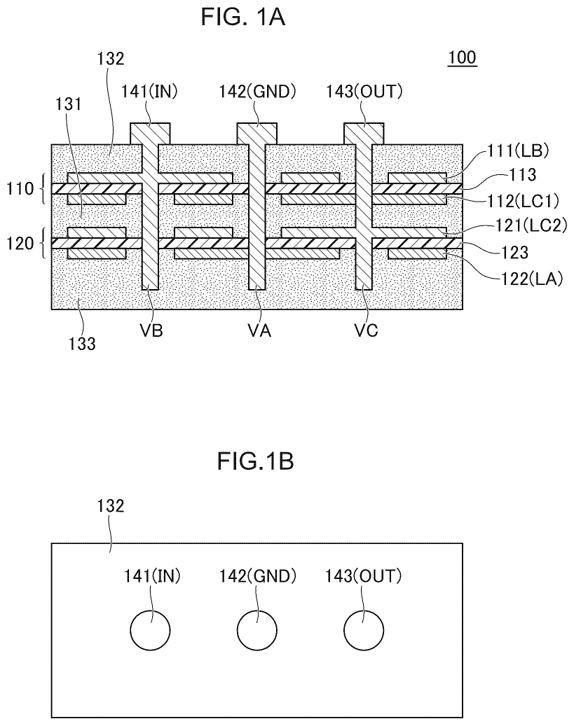

FIG. 1A is a schematic cross-sectional view illustrating a voltage dividing capacitor 100 according to a first embodiment of the technology described herein. FIG. 1B is a schematic top view of the voltage dividing capacitor 100.

As illustrated in FIGS. 1A and 1B, the voltage dividing capacitor 100 according to the first embodiment has two capacitors 110 and 120, insulating resin layers 131 to 133, and three via conductors VA to VC. The capacitor 110 includes an upper electrode layer 111, a lower electrode layer 112, and a dielectric film 113 positioned between the upper and lower electrode layers 111 and 112. The capacitor 120 includes an upper electrode layer 121, a lower electrode layer 122, and a dielectric film 123 positioned between the upper and lower electrode layers 121 and 122. The capacitors 110 and 120 are laminated such that the lower electrode layer 112 of the capacitor 110 and the upper electrode layer 121 of the capacitor 120 face each other.

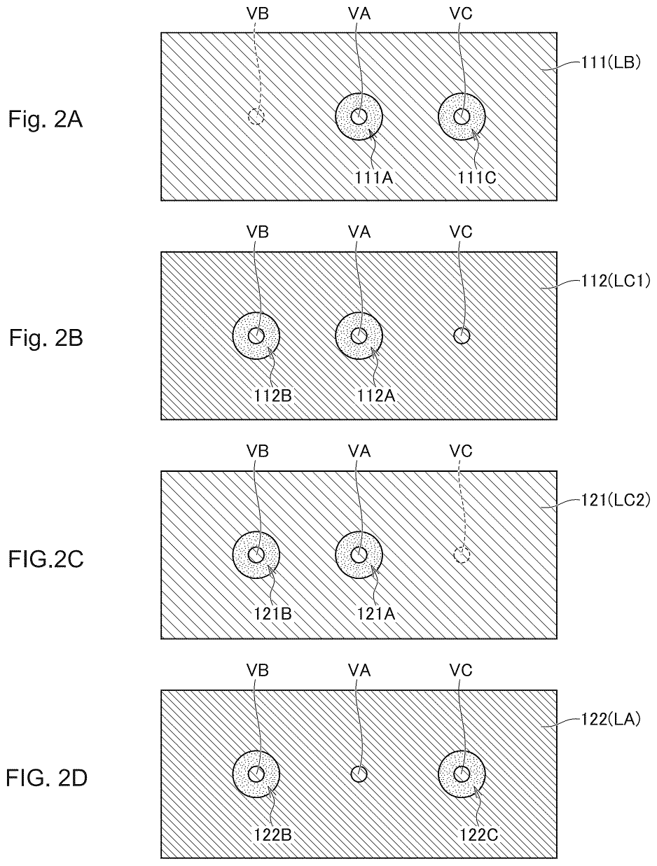

The upper electrode layers 111, 121 and lower electrode layers 112, 122 are each made of a conductive material such as nickel (Ni), copper (Cu), or a rare earth metal. FIG. 2A is a schematic plan view of the upper electrode layer 111, FIG. 2B is a schematic plan view of the lower electrode layer 112, FIG. 2C is a schematic plan view of the upper electrode layer 121, and FIG. 2D is a schematic plan view of the lower electrode layer 122. As illustrated in FIG. 2A, ring-shaped slits 111A and 111C are formed in the upper electrode layer 111 of the capacitor 110. As illustrated in FIG. 2B, ring-shaped slits 112A and 112B are formed in the lower electrode layer 112 of the capacitor 110. As illustrated in FIG. 2C, ring-shaped slits 121A and 121B are formed in the upper electrode layer 121 of the capacitor 120. As illustrated in FIG. 2D, ring-shaped slits 122B and 122C are formed in the lower electrode layer 122 of the capacitor 120.

The dielectric films 113 and 123 are each constituted by a perovskite dielectric material, for example. Examples of the perovskite dielectric material include a ferroelectric material or a paraelectric material having a perovskite structure, such as BaTiO₃ (barium titanate), (Ba₁₋ₓSrₓ) TiO₃ (barium strontium titanate), (Ba₁₋ₓCaₓ) TiO₃, PbTiO₃, Pb (ZrₓTi₁₋ₓ)O₃, (Sr₁₋ₓCaₓ), (Ti_{1-y}Zr_{y})O₃, Ba(Mg_{1/3}Ta_{2/3}), a composite perovskite relaxer type ferroelectric material represented by Pb (Mg_{1/3}Nb_{2/3})O₃, and the like, a bismuth layer compound represented by Bi₄Ti₃O₁₂ and SrBi₂Ta₂O₉, a tungsten bronze type ferroelectric material represented by (Sr₁₋ₓBaₓ) Nb₂O₆ and PbNb₂O₆. Here, in the above-described perovskite structure, perovskite relaxer type ferroelectric material, bismuth layer compound, and tungsten bronze type ferroelectric material, the ratio of A site and B site is usually an integer ratio but may be purposely shifted from the integer ratio in order to improve characteristics. In order to control the characteristics of the dielectric films 113 and 123, the dielectric films 113 and 123 may appropriately contain an additive substance as a subcomponent. The relative permittivity (Er) of each of the dielectric films 113 and 123 is 10 or more, for example. Further, the larger the dielectric withstand voltage of each of the dielectric films 113 and 123, the better, and there is not particular restriction on the upper limit value thereof. The larger the relative permittivity of each of the dielectric films 113 and 123, the better, and there is not particular restriction on the upper limit value thereof. The thickness of each of the dielectric films 113 and 123 is about 10 nm to about 6000 nm, for example.

The insulating resin layer 131 is positioned between the lower electrode layer 112 of the capacitor 110 and the upper electrode layer 121 of the capacitor 120. The insulating resin layer 132 covers the upper electrode layer 111 of the capacitor 110. The insulating resin layer 133 covers the lower electrode layer 122 of the capacitor 120. The insulating resin layers 131 to 133 are made of a resin material and may contain a core material such as glass cloth.

The via conductors VA to VC each penetrate the insulating resin layer 132, capacitor 110, insulating resin layer 131, and capacitor 120. The via conductor VB is connected to the upper electrode layer 111 of the capacitor 110. On the other hand, the via conductor VB is separated from the other electrode layers 112, 121, and 122 by the slits 112B, 121B, and 122B. The upper electrode layer 111 of the capacitor 110 connected to the via conductor VB constitutes an electrode layer LB applied with a predetermined potential. The via conductor VA is connected to the lower electrode layer 122 of the capacitor 120. The via conductor VA is separated from the other electrode layers 111, 112, and 121 by the slits 111A, 112A, and 121A. The lower electrode layer 122 the capacitor 120 connected to the via conductor VA constitutes an electrode layer LA applied with a predetermined potential.

The via conductor VC is connected to the lower electrode layer 112 of the capacitor 110 and the upper electrode layer 121 of the capacitor 120. On the other hand, the via conductor VC is separated from the other electrode layers 111 and 122 by the slits 1110 and 122C. The lower electrode layer 112 of the capacitor 110 constitutes an electrode layer LC1, and the upper electrode layer 121 of the capacitor 120 constitutes an electrode layer LC2. The electrode layers LC1 and LC2 are connected to each other through the via conductor VC and, accordingly, they are at the same potential. The lower electrode layer 112 of the capacitor 110 constituting the electrode layer LC1 and the upper electrode layer 121 of the capacitor 120 constituting the electrode layer LC2 face each other through the insulating resin layer 131; however, since they are at the same potential, no voltage is applied to the insulating resin layer 131.

Terminal electrodes 141 to 143 are provided on the surface of the insulating resin layer 132. The terminal electrodes 141 to 143 are respectively disposed at positions overlapping the via conductors VB, VA, and VC in a plan view and respectively connected to the upper ends of the via conductors VB, VA, and VC. In the example illustrated in FIG. 1A, the lower ends of the via conductors VB, VA, and VC are embedded in the insulating resin layer 133 without being exposed therefrom.

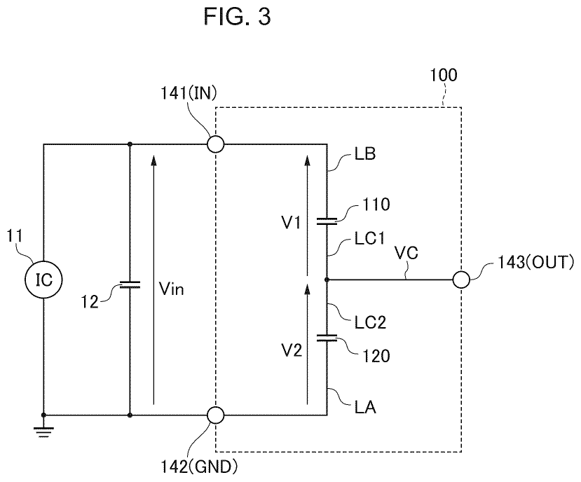

FIG. 3 is an equivalent circuit diagram of the voltage dividing capacitor 100 according to the present embodiment.

As illustrated in FIG. 3, the voltage dividing capacitor 100 according to the present embodiment has a circuit configuration in which the capacitors 110 and 120 are connected in series between the terminal electrodes 141 and 142. The node between the capacitors 110 and 120 is connected to the terminal electrode 143. The terminal electrode 141 is an input terminal (IN) and is connected to the electrode layer LB through the via conductor VB. The terminal electrode 142 is a ground terminal (GND) and is connected to the electrode layer LA through the via conductor VA. The terminal electrode 143 is an output terminal (OUT) and is connected in common to the electrode layers LC1 and LC2 through the via conductor VC. The terminal electrode 141 (IN) is connected to a power supply circuit 11, and the terminal electrode 142 (GND) is grounded, whereby the voltage dividing capacitor 100 according to the present embodiment can output a dropped voltage from the terminal electrode 143 (OUT). An input capacitor 12 may be connected between the terminal electrodes 141 and 142.

When an input voltage supplied from the power supply circuit 11 is assumed to be Vin, an output voltage V2 has a level obtained by dividing the input voltage Vin by the capacitors 110 and 120. Further, when the capacitance of the capacitor 110 is assumed to be C1, the capacitance of the capacitor 120 is assumed to be C2, the voltage to be applied to the capacitor 110 is assumed to be V1, and the voltage to be applied to the capacitor 120 is assumed to be V2, C1×V1=C2×V2 is satisfied by the law of charge conservation. Therefore, when C1 is made smaller than C2 (C1<C2), V1>V2 is satisfied, whereby the output voltage V2 can be further dropped.

As described above, the voltage dividing capacitor 100 according to the present embodiment is a three-terminal type thin film capacitor having a structure in which two capacitors 110 and 120 are laminated and is configured to output a dropped voltage from the terminal electrode 143 (OUT). In addition, no voltage is applied to the insulating resin layer 131 positioned between the capacitors 110 and 120, and thus high insulating property is not required for the insulating resin layer 131, making it possible to reduce the thickness of the insulating resin layer 131. Alternatively, the insulating resin layer 131 may be omitted to allow the lower electrode layer 112 of the capacitor 110 and the upper electrode layer 121 of the capacitor 120 to contact each other.

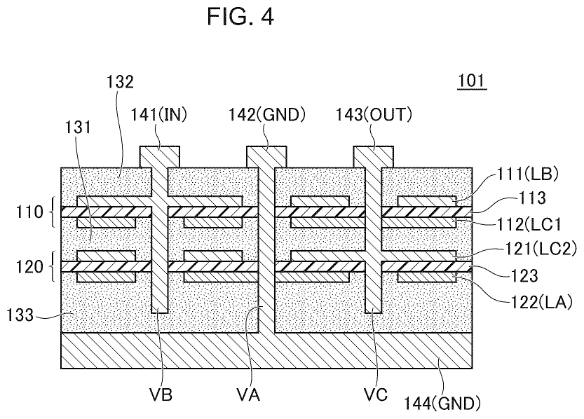

FIG. 4 is a schematic cross-sectional view illustrating a voltage dividing capacitor 101 according to a first modification of the present embodiment.

As illustrated in FIG. 4, the voltage dividing capacitor 101 according to the first modification of the present embodiment further has a terminal electrode 144 covering the insulating resin layer 133. The lower end of the via conductor VA is connected to the terminal electrode 144. The terminal electrode 144 may cover the entire surface of the insulating resin layer 133. This allows the terminal electrode 144 to be used as another ground terminal. Further, connecting the terminal electrode 144 to a large-area ground pattern allows for the achievement of high heat dissipation.

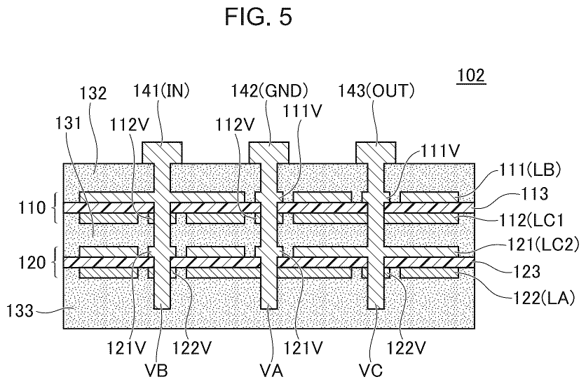

FIG. 5 is a schematic cross-sectional view illustrating a voltage dividing capacitor 102 according to a second modification of the present embodiment.

As illustrated in FIG. 5, in the voltage dividing capacitor 102 according to the second modification of the present embodiment, the upper electrode layer 111 of the capacitor 110 has a region 111V connected to the via conductors VA and VC, the lower electrode layer 112 of the capacitor 110 has a region 112V connected to the via conductors VA and VB, the upper electrode layer 121 of the capacitor 120 has a region 121V connected to the via conductors VA and VB, and the lower electrode layer 122 of the capacitor 120 has a region 122V connected to the via conductors VB and VC. The region 111V is separated from the main region of the upper electrode layer 111 that is connected to the via conductor VB by the slits 111A and 111C illustrated in FIG. 2A. The region 112V is separated from the main region of the lower electrode layer 112 that is connected to the via conductor VC by the slits 112A and 112B illustrated in FIG. 2B. The region 121V is separated from the main region of the upper electrode layer 121 that is connected to the via conductor VC by the slits 121A and 121B illustrated in FIG. 2C. The region 122V is separated from the main region of the lower electrode layer 122 that is connected to the via conductor VA by the slits 122B and 122C illustrated in FIG. 2D.

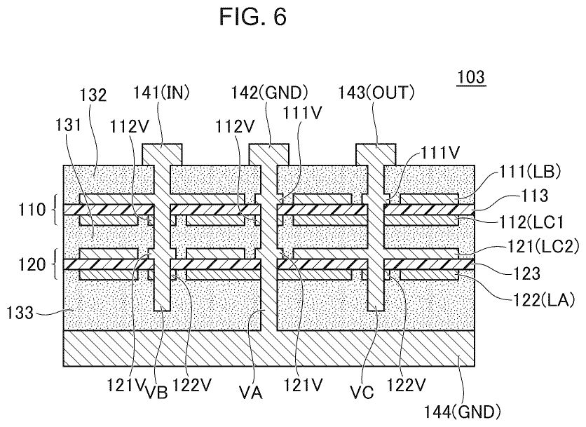

FIG. 6 is a schematic cross-sectional view illustrating a voltage dividing capacitor 103 according to a third modification of the present embodiment.

As illustrated in FIG. 6, the voltage dividing capacitor 103 according to the third modification of the present embodiment has a structure obtained by combining the voltage dividing capacitor 101 according to the first modification and the voltage dividing capacitor 102 according to the second modification.

### Second Embodiment

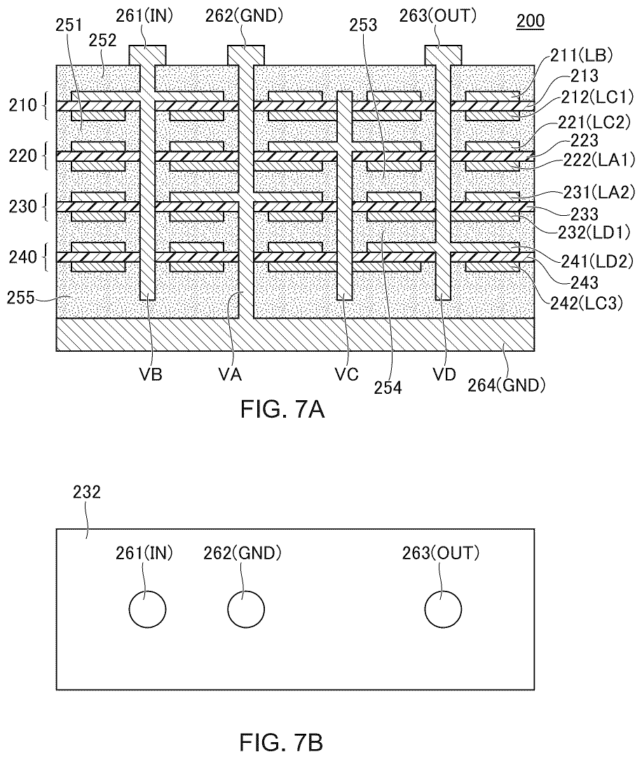

FIG. 7A is a schematic cross-sectional view illustrating a voltage dividing capacitor 200 according to a second embodiment of the technology described herein. FIG. 7B is a schematic top view of the voltage dividing capacitor 200.

As illustrated in FIGS. 7A and 7B, the voltage dividing capacitor 200 according to the second embodiment has four capacitors 210, 220, 230, and 240, insulating resin layers 251 to 255, and four via conductors VA to VD.

The capacitor 210 includes an upper electrode layer 211, a lower electrode layer 212, and a dielectric film 213 positioned between the upper and lower electrode layers 211 and 212. The capacitor 220 includes an upper electrode layer 221, a lower electrode layer 222, and a dielectric film 223 positioned between the upper and lower electrode layers 221 and 222. The capacitor 230 includes an upper electrode layer 231, a lower electrode layer 232, and a dielectric film 233 positioned between the upper and lower electrode layers 231 and 232. The capacitor 240 includes an upper electrode layer 241, a lower electrode layer 242, and a dielectric film 243 positioned between the upper and lower electrode layers 241 and 242.

The capacitors 210 and 220 are laminated such that the lower electrode layer 212 of the capacitor 210 and the upper electrode layer 221 of the capacitor 220 face each other. The capacitors 220 and 230 are laminated such that the lower electrode layer 222 of the capacitor 220 and the upper electrode layer 231 of the capacitor 230 2 face each other. The capacitors 230 and 240 are laminated such that the lower electrode layer 232 of the capacitor 230 and the upper electrode layer 241 of the capacitor 240 face each other.

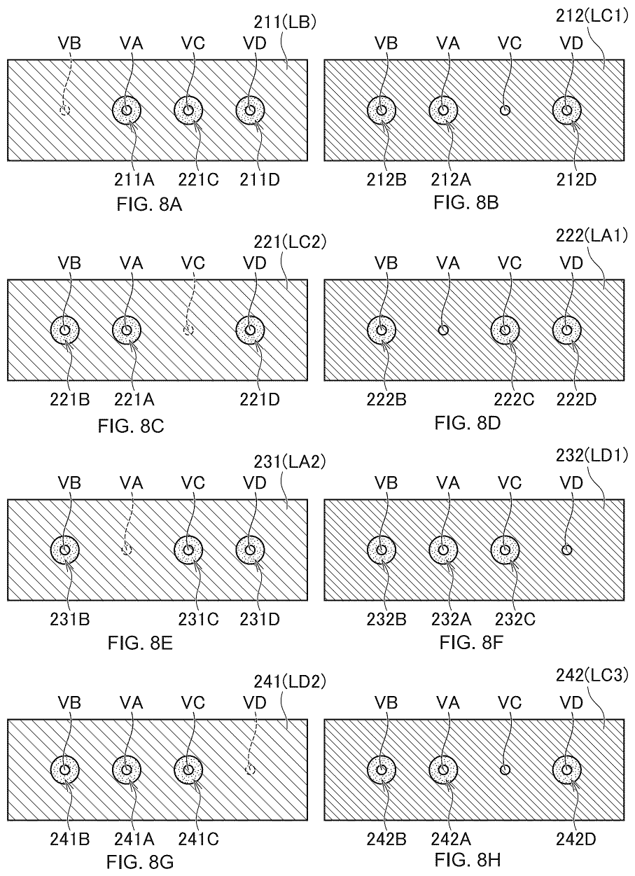

FIG. 8A is a schematic plan view of the upper electrode layer 211, FIG. 8B is a schematic plan view of the lower electrode layer 212, FIG. 8C is a schematic plan view of the upper electrode layer 221, FIG. 8D is a schematic plan view of the lower electrode layer 222, FIG. 8E is a schematic plan view of the upper electrode layer 231, FIG. 8F is a schematic plan view of the lower electrode layer 232, FIG. 8G is a schematic plan view of the upper electrode layer 241, and FIG. 8H is a schematic plan view of the lower electrode layer 242.

As illustrated in FIG. 8A, ring-shaped slits 211A, 211C, and 211D are formed in the upper electrode layer 211 of the capacitor 210. As illustrated in FIG. 8B, ring-shaped slits 212A, 212B, and 212D are formed in the lower electrode layer 212 of the capacitor 210. As illustrated in FIG. 8C, ring-shaped slits 221A, 221B, and 221D are formed in the upper electrode layer 221 of the capacitor 220. As illustrated in FIG. 8D, ring-shaped slits 222B, 222C, and 222D are formed in the lower electrode layer 222 of the capacitor 220. As illustrated in FIG. 8E, ring-shaped slits 231B, 231C, and 231D are formed in the upper electrode layer 231 of the capacitor 230. As illustrated in FIG. 8F, ring-shaped slits 232A, 232B, and 232C are formed in the lower electrode layer 232 of the capacitor 230. As illustrated in FIG. 8G, ring-shaped slits 241A, 241B, and 241C are formed in the upper electrode layer 241 of the capacitor 240. As illustrated in FIG. 8H, ring-shaped slits 242A, 242B, and 242D are formed in the lower electrode layer 242 of the capacitor 240.

The insulating resin layer 251 is positioned between the lower electrode layer 212 of the capacitor 210 and the upper electrode layer 221 of the capacitor 220. The insulating resin layer 252 covers the upper electrode layer 211 of the capacitor 210. The insulating resin layer 253 is positioned between the lower electrode layer 222 of the capacitor 220 and the upper electrode layer 231 of the capacitor 230. The insulating resin layer 254 is positioned between the lower electrode layer 232 of the capacitor 230 and the upper electrode layer 241 of the capacitor 240. The insulating resin layer 255 covers the lower electrode layer 242 of the capacitor 240.

The via conductors VA to VD each penetrate the insulating resin layer 252, capacitor 210, insulating resin layer 251, capacitor 220, insulating resin layer 253, capacitor 230, insulating resin layer 254, and capacitor 240.

The via conductor VB is connected to the upper electrode layer 211 of the capacitor 210. On the other hand, the via conductor VB is separated from the other electrode layers 212, 221, 222, 231, 232, 241, and 242 by the slits 212B, 221B, 222B, 231B, 232B, 241B, and 242B. The upper electrode layer 211 of the capacitor 210 connected to the via conductor VB constitutes an electrode layer LB applied with a predetermined potential.

The via conductor VA is connected to the lower electrode layer 222 of the capacitor 220 and the upper electrode layer 231 of the capacitor 230. On the other hand, the via conductor VA is separated from the other electrode layers 211, 212, 221, 232, 241, and 242 by the slits 211A, 212A, 221A, 232A, 241A, and 242A. The lower electrode layer 222 of the capacitor 220 and the upper electrode layer 231 of the capacitor 230, which are connected to the via conductor VA, respectively constitute an electrode layer LA1 and an electrode layer LA2 each applied with a predetermined potential. The electrode layers LA1 and LA2 are connected to each other through the via conductor VA and, accordingly, they are at the same potential. The lower electrode layer 222 of the capacitor 220 constituting the electrode layer LA1 and the upper electrode layer 231 of the capacitor 230 constituting the electrode layer LA2 face each other through the insulating resin layer 253; however, since they are at the same potential, no voltage is applied to the insulating resin layer 253.

The via conductor VC is connected to the lower electrode layer 212 of the capacitor 210, upper electrode layer 221 of the capacitor 220, and lower electrode layer 242 of the capacitor 240. On the other hand, the via conductor VC is separated from the other electrode layers 211, 222, 231, 232, and 241 by the slits 211C, 222C, 231C, 232C, and 241C. The lower electrode layer 212 of the capacitor 210 constitutes an electrode layer LC1, the upper electrode layer 221 of the capacitor 220 constitutes an electrode layer LC2, and the lower electrode layer 242 of the capacitor 240 constitutes an electrode layer LC3. The electrode layers LC1 to LC3 are connected to each other through the via conductor VC and, accordingly, they are at the same potential. The lower electrode layer 212 of the capacitor 210 constituting the electrode layer LC1 and the upper electrode layer 221 of the capacitor 220 constituting the electrode layer LC2 face each other through the insulating resin layer 251; however, since they are at the same potential, no voltage is applied to the insulating resin layer 251.

The via conductor VD is connected to the lower electrode layer 232 of the capacitor 230 and the upper electrode layer 241 of the capacitor 240. On the other hand, the via conductor VD is separated from the other electrode layers 211, 212, 221, 222, 231, and 242 by the slits 211D, 212D, 221D, 222D, 231D, and 242D. The lower electrode layer 232 of the capacitor 230 constitutes an electrode layer LD1, and the upper electrode layer 241 of the capacitor 240 constitutes an electrode layer LD2. The electrode layers LD1 and LD2 are connected to each other through the via conductor VD and, accordingly, they are at the same potential. The lower electrode layer 232 of the capacitor 230 constituting the electrode layer LD1 and the upper electrode layer 241 of the capacitor 240 constituting the electrode layer LD2 face each other through the insulating resin layer 254; however, since they are at the same potential, no voltage is applied to the insulating resin layer 254.

Terminal electrodes 261 to 263 are provided on the surface of the insulating resin layer 252. The terminal electrodes 261 to 263 are respectively disposed at positions overlapping the via conductors VB, VA, and VD in a plan view and respectively connected to the upper ends of the via conductors VB, VA, and VD. On the other hand, the upper end of the via conductor VC is embedded in the insulating resin layer 252 without being exposed therefrom. A terminal electrode 264 is provided on the surface of the insulating resin layer 255. The terminal electrode 264 is connected to the lower end of the via conductor VA. On the other hand, the lower ends of the via conductors VB, VC, and VD are embedded in the insulating resin layer 255 without being exposed therefrom. The terminal electrode 264 may cover the entire surface of the insulating resin layer 255. Connecting the terminal electrode 264 to a large-area ground pattern allows for the achievement of high heat dissipation.

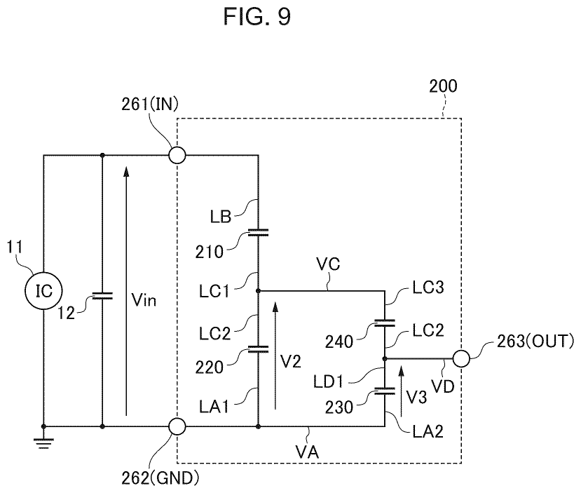

FIG. 9 is an equivalent circuit diagram of the voltage dividing capacitor 200 according to the present embodiment.

As illustrated in FIG. 9, the voltage dividing capacitor 200 according to the present embodiment has a circuit configuration in which the capacitors 210 and 220 are connected in series between the terminal electrodes 261 and 262, and the capacitors 240 and 230 are connected in series between the node between the capacitors 210 and 220 and the terminal electrode 262. The node between the capacitors 240 and 230 is connected to the terminal electrode 263. The terminal electrode 261 is an input terminal (IN) and is connected to the electrode layer LB through the via conductor VB. The terminal electrode 262 is a ground terminal (GND) and is connected in common to the electrode layers LA1 and LA2 through the via conductor VA. The terminal electrode 263 is an output terminal (OUT) and is connected in common to the electrode layers LD1 and LD2 through the via conductor VD.

The terminal electrode 261 (IN) is connected to the power supply circuit 11, and the terminal electrode 262 (GND) is grounded, whereby the voltage dividing capacitor 200 according to the present embodiment can output a dropped voltage from the terminal electrode 263 (OUT).

When an input voltage supplied from the power supply circuit 11 is assumed to be Vin, a voltage V2 to be applied to the capacitor 220 has a level obtained by dividing the input voltage Vin by the capacitors 210 and 220. Further, a voltage V3 to be applied to the capacitor 230 has a level obtained by dividing the voltage V2 by the capacitors 240 and 230. Thus, the voltage V3 to be output from the terminal electrode 263 as the output terminal (OUT) can be brought to a lower level than the voltage V2.

In the voltage dividing capacitor 200 according to the present embodiment, the capacitors 210, 220, 230, and 240 are laminated in this order and connected in series in this order. This brings the electrode layer pairs facing each other respectively through the insulating resin layers 251, 253, and 254 to the same potential, so that no voltage is applied to the insulating resin layers 251, 253, and 254.

### Third Embodiment

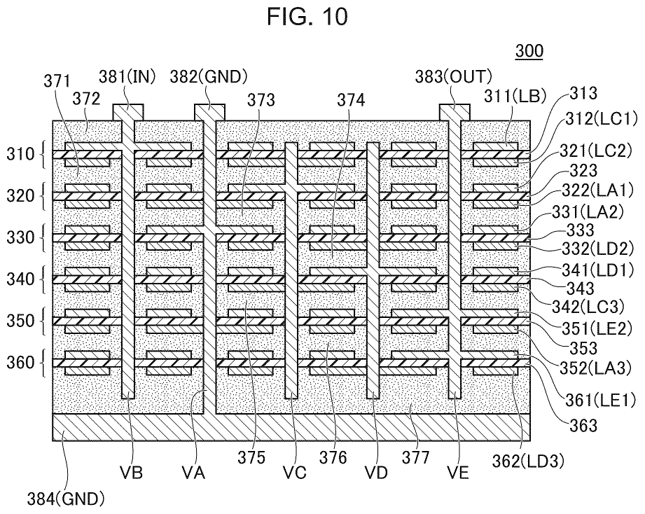

FIG. 10 is a schematic cross-sectional view illustrating a voltage dividing capacitor 300 according to a third embodiment of the technology described herein.

As illustrated in FIG. 10, the voltage dividing capacitor 300 according to the third embodiment has six capacitors 310, 320, 330, 340, 350, and 360, insulating resin layers 371 to 377, and five via conductors VA to VE.

The capacitor 310 includes an upper electrode layer 311, a lower electrode layer 312, and a dielectric film 313 positioned between the upper and lower electrode layers 311 and 312. The capacitor 320 includes an upper electrode layer 321, a lower electrode layer 322, and a dielectric film 323 positioned between the upper and lower electrode layers 321 and 322. The capacitor 330 includes an upper electrode layer 331, a lower electrode layer 332, and a dielectric film 333 positioned between the upper and lower electrode layers 331 and 332. The capacitor 340 includes an upper electrode layer 341, a lower electrode layer 342, and a dielectric film 343 positioned between the upper and lower electrode layers 341 and 342. The capacitor 350 includes an upper electrode layer 351, a lower electrode layer 352, and a dielectric film 353 positioned between the upper and lower electrode layers 351 and 352. The capacitor 360 includes an upper electrode layer 361, a lower electrode layer 362, and a dielectric film 363 positioned between the upper and lower electrode layers 361 and 362.

The capacitors 310 and 320 are laminated such that the lower electrode layer 312 of the capacitor 310 and the upper electrode layer 321 of the capacitor 320 face each other. The capacitors 320 and 330 are laminated such that the lower electrode layer 322 of the capacitor 320 and the upper electrode layer 331 of the capacitor 330 face each other. The capacitors 330 and 340 are laminated such that the lower electrode layer 332 of the capacitor 330 and the upper electrode layer 341 of the capacitor 340 face each other. The capacitors 340 and 350 are laminated such that the lower electrode layer 342 of the capacitor 340 and the upper electrode layer 351 of the capacitor 350 face each other. The capacitors 350 and 360 are laminated such that the lower electrode layer 352 of the capacitor 350 and the upper electrode layer 361 of the capacitor 360 face each other.

The insulating resin layer 371 is positioned between the lower electrode layer 312 of the capacitor 310 and the upper electrode layer 321 of the capacitor 320. The insulating resin layer 372 covers the upper electrode layer 311 of the capacitor 310. The insulating resin layer 373 is positioned between the lower electrode layer 322 of the capacitor 320 and the upper electrode layer 331 of the capacitor 330. The insulating resin layer 374 is positioned between the lower electrode layer 332 of the capacitor 330 and the upper electrode layer 341 of the capacitor 340. The insulating resin layer 375 is positioned between the lower electrode layer 342 of the capacitor 340 and the upper electrode layer 351 of the capacitor 350. The insulating resin layer 376 is positioned between the lower electrode layer 352 of the capacitor 350 and the upper electrode layer 361 of the capacitor 360. The insulating resin layer 377 covers the lower electrode layer 362 of the capacitor 360.

The via conductors VA to VE each penetrate the insulating resin layer 372, capacitor 310, insulating resin layer 371, capacitor 320, insulating resin layer 373, capacitor 330, insulating resin layer 374, capacitor 340, insulating resin layer 375, capacitor 350, insulating resin layer 376, and capacitor 360.

The via conductor VB is connected to the upper electrode layer 311 of the capacitor 310. The upper electrode layer 311 of the capacitor 310 connected to the via conductor VB constitutes an electrode layer LB applied with a predetermined potential.

The via conductor VA is connected to the lower electrode layer 322 of the capacitor 320, upper electrode layer 331 of the capacitor 330, and lower electrode layer 352 of the capacitor 350. The lower electrode layer 322 of the capacitor 320, upper electrode layer 331 of the capacitor 330, and lower electrode layer 352 of the capacitor 350 connected to via conductor VA respectively constitute electrode layers LA1, LA2, and LA3 each applied with a predetermined potential. The electrode layers LA1 to LA3 are connected to each other through the via conductor VA and, accordingly, they are at the same potential. The lower electrode layer 322 of the capacitor 320 constituting the electrode layer LA1 and the upper electrode layer 331 of the capacitor 330 constituting the electrode layer LA2 face each other through the insulating resin layer 373; however, since they are at the same potential, no voltage is applied to the insulating resin layer 373.

The via conductor VC is connected to the lower electrode layer 312 of the capacitor 310, upper electrode layer 321 of the capacitor 320, and lower electrode layer 342 of the capacitor 340. The lower electrode layer 312 of the capacitor 310 constitutes an electrode layer LC1, the upper electrode layer 321 of the capacitor 320 constitutes an electrode layer LC2, and the lower electrode layer 342 of the capacitor 340 constitutes an electrode layer LC3. The electrode layers LC1 to LC3 are connected to each other through the via conductor VC and, accordingly, they are at the same potential. The lower electrode layer 312 of the capacitor 310 constituting the electrode layer LC1 and the upper electrode layer 321 of the capacitor 320 constituting the electrode layer LC2 face each other through the insulating resin layer 371; however, since they are at the same potential, no voltage is applied to the insulating resin layer 371.

The via conductor VD is connected to the lower electrode layer 332 of the capacitor 330, upper electrode layer 341 of the capacitor 340, and lower electrode layer 362 of the capacitor 360. The lower electrode layer 332 of the capacitor 330 constitutes an electrode layer LD2, the upper electrode layer 341 of the capacitor 340 constitutes an electrode layer LD1, and the lower electrode layer 362 of the capacitor 360 constitutes an electrode layer LD3. The electrode layers LD1 to LD3 are connected to each other through the via conductor VD and, accordingly, they are at the same potential. The lower electrode layer 332 of the capacitor 330 constituting the electrode layer LD2 and the upper electrode layer 341 of the capacitor 340 constituting the electrode layer LD1 face each other through the insulating resin layer 374; however, since they are at the same potential, no voltage is applied to the insulating resin layer 374.

The via conductor VE is connected to the upper electrode layer 361 of the capacitor 360 and the upper electrode layer 351 of the capacitor 350. The upper electrode layer 361 of the capacitor 360 constitutes an electrode layer LE1, and the upper electrode layer 351 of the capacitor 350 constitutes an electrode layer LE2. The electrode layers LE1 and LE2 are connected to each other through the via conductor VE and, accordingly, they are at the same potential.

Terminal electrodes 381 to 383 are provided on the surface of the insulating resin layer 372. The terminal electrodes 381 to 383 are respectively disposed at positions overlapping the via conductors VB, VA, and VE in a plan view and respectively connected to the upper ends of the via conductors VB, VA, and VE. On the other hand, the upper ends of the via conductors VC and VD are embedded in the insulating resin layer 372 without being exposed therefrom. A terminal electrode 384 is provided on the surface of the insulating resin layer 377. The terminal electrode 384 is connected to the lower end of the via conductor VA. On the other hand, the lower ends of the via conductors VB, VC, VD, and VE are embedded in the insulating resin layer 377 without being exposed therefrom. The terminal electrode 384 may cover the entire surface of the insulating resin layer 377. Connecting the terminal electrode 384 to a large-area ground pattern allows for the achievement of high heat dissipation.

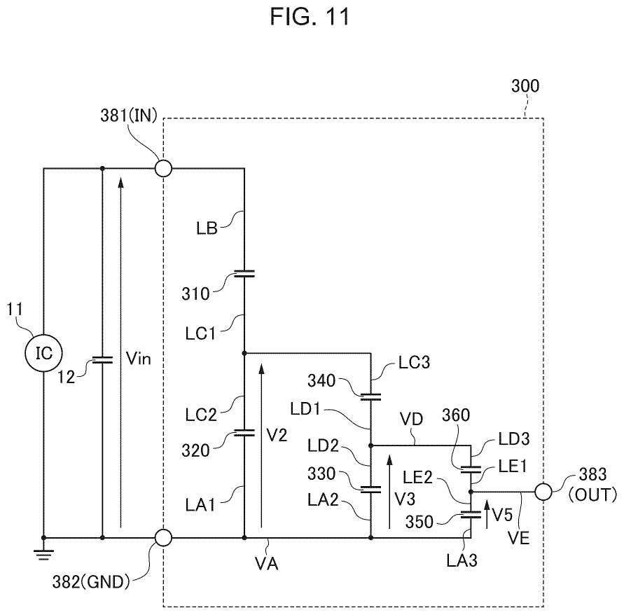

FIG. 11 is an equivalent circuit diagram of the voltage dividing capacitor 300 according to the present embodiment.

As illustrated in FIG. 11, the voltage dividing capacitor 300 according to the present embodiment has a circuit configuration in which the capacitors 310 and 320 are connected in series between the terminal electrodes 381 and 382, the capacitors 340 and 330 are connected in series between the node between the capacitors 310 and 320 and the terminal electrode 382, and capacitors 360 and 350 are connected in series between the node between the capacitors 340 and 330 and terminal electrode 382. The node between the capacitors 360 and 350 is connected to the terminal electrode 383. The terminal electrode 381 is an input terminal (IN) and is connected to the electrode layer LB through the via conductor VB. The terminal electrode 382 is a ground terminal (GND) and is connected in common to the electrode layer LA1 to LA3 through the via conductor VA. The terminal electrode 383 is an output terminal (OUT) and is connected in common to the electrode layers LE1 and LE2 through the via conductor VE.

The terminal electrode 381 (IN) is connected to the power supply circuit 11, and the terminal electrode 382 (GND) is grounded, whereby the voltage dividing capacitor 300 according to the present embodiment can output a dropped voltage from the terminal electrode 383 (OUT).

When an input voltage supplied from the power supply circuit 11 is assumed to be Vin, a voltage V2 to be applied to the capacitor 320 has a level obtained by dividing the input voltage Vin by the capacitors 310 and 320. Further, a voltage V3 to be applied to the capacitor 330 has a level obtained by dividing the voltage V2 by the capacitors 340 and 330. Further, a voltage V5 to be applied to the capacitor 350 has a level obtained by dividing the voltage V3 by the capacitors 360 and 350. Thus, the voltage V5 to be output from the terminal electrode 383 as the output terminal (OUT) can be brought to a lower level than the voltage V3.

The capacitors 310, 320, 330, and 340 included in the voltage dividing capacitor 300 according to the present embodiment are laminated in this order and connected in series in this order. This brings the electrode layer pairs facing each other respectively through the insulating resin layers 371, 373, and 374 to the same potential, so that no voltage is applied to the insulating resin layers 371, 373, and 374.

### Fourth Embodiment

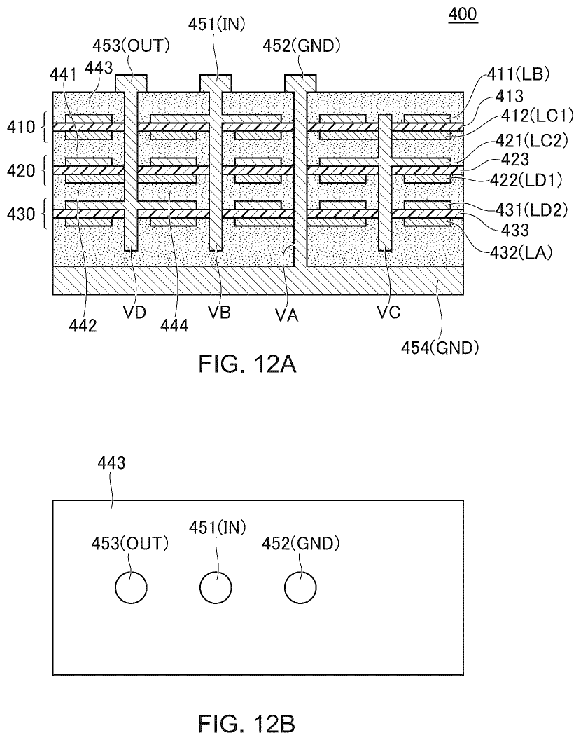

FIG. 12A is a schematic cross-sectional view illustrating a voltage dividing capacitor 400 according to a fourth embodiment of the technology described herein. FIG. 12B is a schematic top view of the voltage dividing capacitor 400.

As illustrated in FIGS. 12A and 12B, the voltage dividing capacitor 400 according to the fourth embodiment has three capacitors 410, 420, and 430, insulating resin layers 441 to 444, and four via conductors VA to VD.

The capacitor 410 includes an upper electrode layer 411, a lower electrode layer 412, and a dielectric film 413 positioned between the upper and lower electrode layers 411 and 412. The capacitor 420 includes an upper electrode layer 421, a lower electrode layer 422, and a dielectric film 423 positioned between the upper and lower electrode layers 421 and 422. The capacitor 430 includes an upper electrode layer 431, a lower electrode layer 432, and a dielectric film 433 positioned between the upper and lower electrode layers 431 and 432. The capacitors 410 and 420 are laminated such that the lower electrode layer 412 of the capacitor 410 and the upper electrode layer 421 of the capacitor 420 face each other. The capacitors 420 and 430 are laminated such that the lower electrode layer 222 of the capacitor 420 and the upper electrode layer 231 of the capacitor 430 face each other.

The insulating resin layer 441 is positioned between the lower electrode layer 412 of the capacitor 410 and the upper electrode layer 421 of the capacitor 420. The insulating resin layer 442 is positioned between the lower electrode layer 422 of the capacitor 420 and the upper electrode layer 431 of the capacitor 430. The insulating resin layer 443 covers the upper electrode layer 411 of the capacitor 410. The insulating resin layer 444 covers the lower electrode layer 432 of the capacitor 430.

The via conductors VA to VD each penetrate the insulating resin layer 443, capacitor 410, insulating resin layer 441, capacitor 420, insulating resin layer 442, and capacitor 430.

The via conductor VB is connected to the upper electrode layer 411 of the capacitor 410. The upper electrode layer 411 of the capacitor 410 connected to the via conductor VB constitutes an electrode layer LB applied with a predetermined potential.

The via conductor VA is connected to the lower electrode layer 432 of the capacitor 430. The lower electrode layer 432 of the capacitor 430 connected to the via conductor VA constitutes an electrode layer LA applied with a predetermined potential.

The via conductor VC is connected to the lower electrode layer 412 of the capacitor 410 and the upper electrode layer 421 of the capacitor 420. The lower electrode layer 412 of the capacitor 410 constitutes an electrode layer LC1, and the upper electrode layer 421 of the capacitor 420 constitutes an electrode layer LC2. The electrode layers LC1 and LC2 are connected to each other through the via conductor VC and, accordingly, they are at the same potential. The lower electrode layer 412 of the capacitor 410 constituting the electrode layer LC1 and the upper electrode layer 421 of the capacitor 420 constituting the electrode layer LC2 face each other through the insulating resin layer 441; however, since they are at the same potential, no voltage is applied to the insulating resin layer 441.

The via conductor VD is connected to the lower electrode layer 422 of the capacitor 420 and the upper electrode layer 431 of the capacitor 430. The lower electrode layer 422 of the capacitor 420 constitutes an electrode layer LD1, and the upper electrode layer 431 of the capacitor 430 constitutes an electrode layer LD2. The electrode layers LD1 and LD2 are connected to each other through the via conductor VD and, accordingly, they are at the same potential. The lower electrode layer 422 of the capacitor 420 constituting the electrode layer LD1 and the upper electrode layer 431 of the capacitor 430 constituting the electrode layer LD2 face each other through the insulating resin layer 442; however, since they are at the same potential, no voltage is applied to the insulating resin layer 442.

Terminal electrodes 451 to 453 are provided on the surface of the insulating resin layer 443. The terminal electrodes 451 to 453 are respectively disposed at positions overlapping the via conductors VB, VA, and VD in a plan view and respectively connected to the upper ends of the via conductors VB, VA, and VD. On the other hand, the upper end of the via conductor VC is embedded in the insulating resin layer 442 without being exposed therefrom. A terminal electrode 454 is provided on the surface of the insulating resin layer 444. The terminal electrode 454 is connected to the lower end of the via conductor VA. On the other hand, the lower ends of the via conductors VB, VC, and VD are embedded in the insulating resin layer 444 without being exposed therefrom. The terminal electrode 454 may cover the entire surface of the insulating resin layer 444. Connecting the terminal electrode 454 to a large-area ground pattern allows for the achievement of high heat dissipation.

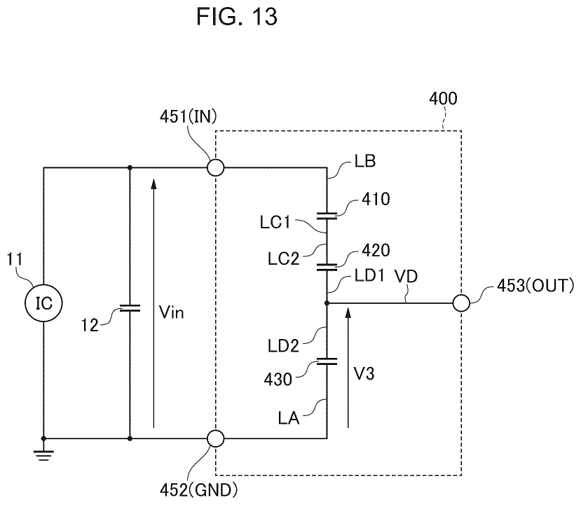

FIG. 13 is an equivalent circuit diagram of the voltage dividing capacitor 400 according to the present embodiment.

As illustrated in FIG. 13, the voltage dividing capacitor 400 according to the present embodiment has a circuit configuration in which the capacitors 410, 420, and 430 are connected in series between the terminal electrodes 451 and 452. The node between the capacitors 420 and 430 is connected to the terminal electrode 453. The terminal electrode 451 is an input terminal (IN) and is connected to the electrode layer LB through the via conductor VB. The terminal electrode 452 is a ground terminal (GND) and is connected to the electrode layer LA through the via conductor VA. The terminal electrode 453 is an output terminal (OUT) and is connected in common to the electrode layers LD1 and LD2 through the via conductor VD.

The terminal electrode 451 (IN) is connected to the power supply circuit 11, and the terminal electrode 452 (GND) is grounded, whereby the voltage dividing capacitor 400 according to the present embodiment can output a dropped voltage from the terminal electrode 453 (OUT).

When an input voltage supplied from the power supply circuit 11 is assumed to be Vin, a voltage V3 to be applied to the capacitor 430 has a level obtained by dividing the input voltage Vin by the capacitors 410, 420, and 430. Thus, in the present embodiment, the three capacitors 410, 420, and 430 are connected in series, so that the voltage V3 can be further dropped.

In the voltage dividing capacitor 400 according to the present embodiment, the capacitors 410, 420, and 430 are laminated in this order and connected in series in this order. This brings the electrode layer pairs facing each other respectively through the insulating resin layers 441 and 442 to the same potential, so that no voltage is applied to the insulating resin layers 441 and 442.

### Fifth Embodiment

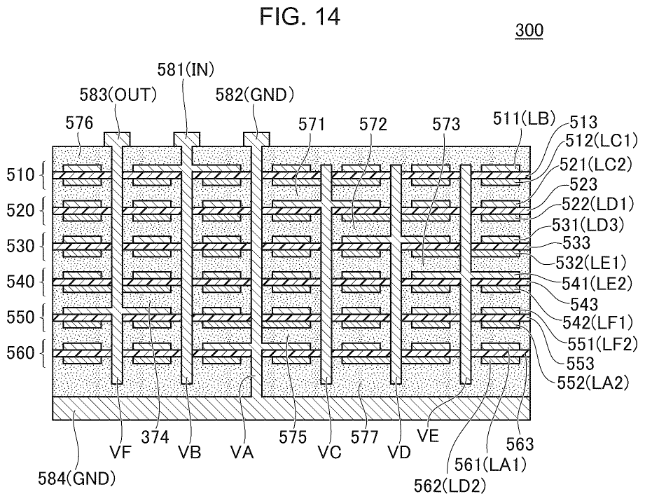

FIG. 14 is a schematic cross-sectional view illustrating a voltage dividing capacitor 500 according to a fifth embodiment of the technology described herein.

As illustrated in FIG. 14, the voltage dividing capacitor 500 according to the fifth embodiment has six capacitors 510, 520, 530, 540, 550, and 560, insulating resin layers 571 to 577, and six via conductors VA to VF.

The capacitor 510 includes an upper electrode layer 511, a lower electrode layer 512, and a dielectric film 513 positioned between the upper and lower electrode layers 511 and 512. The capacitor 520 includes an upper electrode layer 521, a lower electrode layer 522, and a dielectric film 523 positioned between the upper and lower electrode layers 521 and 522. The capacitor 530 includes an upper electrode layer 531, a lower electrode layer 532, and a dielectric film 533 positioned between the upper and lower electrode layers 531 and 532. The capacitor 540 includes an upper electrode layer 541, a lower electrode layer 542, and a dielectric film 543 positioned between the upper and lower electrode layers 541 and 542. The capacitor 550 includes an upper electrode layer 551, a lower electrode layer 552, and a dielectric film 553 positioned between the upper and lower electrode layers 551 and 552. The capacitor 560 includes an upper electrode layer 561, a lower electrode layer 562, and a dielectric film 563 positioned between the upper and lower electrode layers 561 and 562.

The capacitors 510 and 520 are laminated such that the lower electrode layer 512 of the capacitor 510 and the upper electrode layer 521 of the capacitor 520 face each other. The capacitors 520 and 530 are laminated such that the lower electrode layer 522 of the capacitor 520 and the upper electrode layer 531 of the capacitor 530 face each other. The capacitors 530 and 540 are laminated such that the lower electrode layer 532 of the capacitor 530 and the upper electrode layer 541 of the capacitor 540 face each other. The capacitors 540 and 550 are laminated such that the lower electrode layer 542 of the capacitor 540 and the upper electrode layer 551 of the capacitor 550 face each other. The capacitors 550 and 560 are laminated such that the lower electrode layer 552 of the capacitor 550 and the upper electrode layer 561 of the capacitor 560 face each other.

The insulating resin layer 571 is positioned between the lower electrode layer 512 of the capacitor 510 and the upper electrode layer 521 of the capacitor 520. The insulating resin layer 572 is positioned between the lower electrode layer 522 of the capacitor 520 and the upper electrode layer 531 of the capacitor 530. The insulating resin layer 573 is positioned between the lower electrode layer 532 of the capacitor 530 and the upper electrode layer 541 of the capacitor 540. The insulating resin layer 574 is positioned between the lower electrode layer 542 of the capacitor 540 and the upper electrode layer 551 of the capacitor 550. The insulating resin layer 575 is positioned between the lower electrode layer 552 of the capacitor 550 and the upper electrode layer 561 of the capacitor 560. The insulating resin layer 576 covers the upper electrode layer 511 of the capacitor 510. The insulating resin layer 577 covers the lower electrode layer 562 of the capacitor 560.

The via conductors VA to VF each penetrate the insulating resin layer 576, capacitor 510, insulating resin layer 571, capacitor 520, insulating resin layer 572, capacitor 530, insulating resin layer 573, capacitor 540, insulating resin layer 574, capacitor 550, insulating resin layer 575, and capacitor 560.

The via conductor VB is connected to the upper electrode layer 511 of the capacitor 510. The upper electrode layer 511 of the capacitor 510 connected to the via conductor VB constitutes an electrode layer LB applied with a predetermined potential.

The via conductor VA is connected to the lower electrode layer 552 of the capacitor 550 and the upper electrode layer 561 of the capacitor 560. The lower electrode layer 552 of the capacitor 550 and the upper electrode layer 561 of the capacitor 560 connected to the via conductor VA respectively constitute electrode layers LA1 and LA2 each applied with a predetermined potential. The electrode layers LA1 and LA2 are connected to each other through the via conductor VA and, accordingly, they are at the same potential. The lower electrode layer 552 of the capacitor 550 constituting the electrode layer LA1 and the upper electrode layer 561 of the capacitor 560 constituting the electrode layer LA2 face each other through the insulating resin layer 575; however, since they are at the same potential, no voltage is applied to the insulating resin layer 575.

The via conductor VC is connected to the lower electrode layer 512 of the capacitor 510 and the upper electrode layer 521 of the capacitor 520. The lower electrode layer 512 of the capacitor 510 constitutes an electrode layer LC1, and the upper electrode layer 521 of the capacitor 520 constitutes an electrode layer LC2. The electrode layers LC1 and LC2 are connected to each other through the via conductor VC and, accordingly, they are at the same potential. The lower electrode layer 512 of the capacitor 510 constituting the electrode layer LC1 and the upper electrode layer 521 of the capacitor 520 constituting the electrode layer LC2 face each other through the insulating resin layer 571; however, since they are at the same potential, no voltage is applied to the insulating resin layer 571.

The via conductor VD is connected to the lower electrode layer 522 of the capacitor 520, the upper electrode layer 531 of the capacitor 530, and the lower electrode layer 562 of the capacitor 560. The lower electrode layer 522 of the capacitor 520 constitutes an electrode layer LD1, the upper electrode layer 531 of the capacitor 530 constitutes an electrode layer LD3, and the lower electrode layer 562 of the capacitor 560 constitutes an electrode layer LD2. The electrode layers LD1 to LD3 are connected to each other through the via conductor VD and, accordingly, they are at the same potential. The lower electrode layer 522 of the capacitor 520 constituting the electrode layer LD1 and the upper electrode layer 531 of the capacitor 530 constituting the electrode layer LD3 face each other through the insulating resin layer 572; however, since they are at the same potential, no voltage is applied to the insulating resin layer 572.

The via conductor VE is connected to the lower electrode layer 532 of the capacitor 530 and the upper electrode layer 541 of the capacitor 540. The lower electrode layer 531 of the capacitor 530 constitutes an electrode layer LE1, and the upper electrode layer 541 of the capacitor 540 constitutes an electrode layer LE2. The electrode layers LE1 and LE2 are connected to each other through the via conductor VE and, accordingly, they are at the same potential. The lower electrode layer 532 of the capacitor 530 constituting the electrode layer LE1 and the upper electrode layer 541 of the capacitor 540 constituting the electrode layer LE2 face each other through the insulating resin layer 573; however, since they are at the same potential, no voltage is applied to the insulating resin layer 573.

The via conductor VF is connected to the lower electrode layer 542 of the capacitor 540 and the upper electrode layer 551 of the capacitor 550. The lower electrode layer 541 of the capacitor 540 constitutes an electrode layer LF1, and the upper electrode layer 551 of the capacitor 550 constitutes an electrode layer LF2. The electrode layers LF1 and LF2 are connected to each other through the via conductor VF and, accordingly, they are at the same potential. The lower electrode layer 542 of the capacitor 540 constituting the electrode layer LF1 and the upper electrode layer 551 of the capacitor 550 constituting the electrode layer LF2 face each other through the insulating resin layer 574; however, since they are at the same potential, no voltage is applied to the insulating resin layer 574.

Terminal electrodes 581 to 583 are provided on the surface of the insulating resin layer 576. The terminal electrodes 581 to 583 are respectively disposed at positions overlapping the via conductors VB, VA, and VF in a plan view and respectively connected to the upper ends of the via conductors VB, VA, and VF. On the other hand, the upper ends of the via conductors VC, VD, and VE are embedded in the insulating resin layer 576 without being exposed therefrom. A terminal electrode 584 is provided on the surface of the insulating resin layer 577. The terminal electrode 584 is connected to the lower end of the via conductor VA. On the other hand, the lower ends of the via conductors VB, VC, VD, VE, and VF are embedded in the insulating resin layer 577 without being exposed therefrom. The terminal electrode 584 may cover the entire surface of the insulating resin layer 577. Connecting the terminal electrode 584 to a large-area ground pattern allows for the achievement of high heat dissipation.

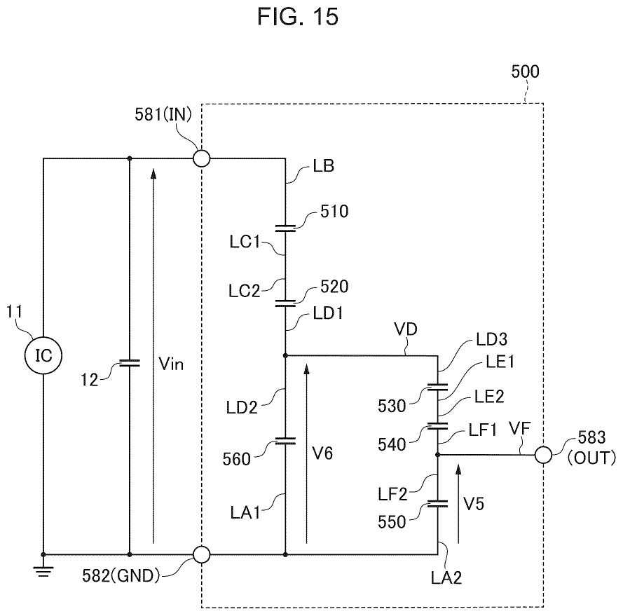

FIG. 15 is an equivalent circuit diagram of the voltage dividing capacitor 500 according to the present embodiment.

As illustrated in FIG. 15, the voltage dividing capacitor 500 according to the present embodiment has a circuit configuration in which the capacitors 510, 520, and 530 are connected in series between the terminal electrodes 581 and 582 and the capacitors 530, 540, and 550 are connected in series between the node between the capacitors 520 and 560 and the terminal electrode 582. The node between the capacitors 540 and 550 is connected to the terminal electrode 583. The terminal electrode 581 is an input terminal (IN) and is connected to the electrode layer LB through the via conductor VB. The terminal electrode 582 is a ground terminal (GND) and is connected in common to the electrode layers LA1 and LA2 through the via conductor VA. The terminal electrode 583 is an output terminal (OUT) and is connected in common to the electrode layers LF1 and LF2 through the via conductor VF.

The terminal electrode 581 (IN) is connected to the power supply circuit 11, and the terminal electrode 582 (GND) is grounded, whereby the voltage dividing capacitor 500 according to the present embodiment can output a dropped voltage from the terminal electrode 583 (OUT).

When an input voltage supplied from the power supply circuit 11 is assumed to be Vin, a voltage V6 to be applied to the capacitor 560 has a level obtained by dividing the input voltage Vin by the capacitors 510, 520, and 560. Further, a voltage V5 to be applied to the capacitor 550 has a level obtained by dividing the voltage V6 by the capacitors 530, 540, and 550. Thus, the voltage V5 to be output from the terminal electrode 583 as the output terminal (OUT) can be brought to a lower level than the voltage V6.

In the voltage dividing capacitor 500 according to the present embodiment, the capacitors 510, 520, 530, 540, 550, and 560 are laminated in this order and connected in series in this order. This brings the electrode layer pairs facing each other respectively through the insulating resin layers 571 and 575 to the same potential, so that no voltage is applied to the insulating resin layers 571 and 575.

While the preferred embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A voltage dividing capacitor according to an aspect of the present disclosure includes: a first capacitor having a first upper electrode layer, a first lower electrode layer, and a first dielectric layer positioned between the first upper electrode layer and the first lower electrode layer; a second capacitor having a second upper electrode layer, a second lower electrode layer, and a second dielectric layer positioned between the second upper electrode layer and the second lower electrode layer; a first insulating resin layer positioned between the first lower electrode layer and the second upper electrode layer; and first, second, and third via conductors penetrating the first capacitor, the first insulating resin layer and the second capacitor, wherein the first via conductor is connected to the first upper electrode layer, the second via conductor is connected to the second lower electrode layer, and the third via conductor is connected to the first lower electrode layer and second upper electrode layer. Thus, when a voltage is applied between the first and second via conductors, a divided voltage appears at the third via conductor.

The above voltage dividing capacitor may further include a first terminal electrode connected to the first via conductor, and a second terminal electrode connected to the second via conductor. This allows the first and second terminal electrodes to be used respectively as an input terminal and a ground terminal.

The above voltage dividing capacitor may further include a second insulating resin layer that covers the first upper electrode layer of the first capacitor, and the first and second terminal electrodes may be provided on the second insulating resin layer. This allows the supply of an input voltage and a ground potential from the same surface of the voltage dividing capacitor.

The above voltage dividing capacitor may further include a third terminal electrode connected to the third via conductor, and the third terminal electrode may be provided on the second insulating resin layer. This allows the supply of an input voltage and a ground potential and take-out of an output voltage from the same surface of the voltage dividing capacitor.

The above voltage dividing capacitor may further include a third insulating resin layer that covers the second lower electrode layer of the second capacitor and a fourth terminal electrode provided on the third insulating resin layer and connected to the second via conductor. This can enhance heat dissipation.

The above voltage dividing capacitor may further include: a third capacitor having a third upper electrode layer, a third lower electrode layer, and a third dielectric layer positioned between the third upper electrode layer and the third lower electrode layer; a fourth capacitor having a fourth upper electrode layer, a fourth lower electrode layer, and a fourth dielectric layer positioned between the fourth upper electrode layer and the fourth lower electrode layer; a third insulating resin layer positioned between the second lower electrode layer and the third upper electrode layer; a fourth insulating resin layer positioned between the third lower electrode layer and the fourth upper electrode layer; and a fourth via conductor penetrating the first capacitor, second capacitor, third capacitor, and fourth capacitor. The second via conductor may further be connected to the third upper electrode layer, the third via conductor may further be connected to the fourth lower electrode layer, and the fourth via conductor may be connected to the third lower electrode layer and the fourth upper electrode layer. Thus, when a voltage is applied between the first and second via conductors, a voltage divided in two steps appears at the fourth via conductor.

The above voltage dividing capacitor may further include a third terminal electrode connected to the fourth via conductor, and the third terminal electrode may be provided on the second insulating resin layer. This allows the supply of an input voltage and a ground potential and take-out of an output voltage from the same surface of the voltage dividing capacitor.

In the above voltage dividing capacitor, one end of the third via conductor may be embedded in the second insulating resin layer without being exposed therefrom. This can reduce the number of the terminal electrodes.

The above voltage dividing capacitor may further include: a fifth capacitor having a fifth upper electrode layer, a fifth lower electrode layer, and a fifth dielectric layer positioned between the fifth upper electrode layer and the fifth lower electrode layer; a sixth capacitor having a sixth upper electrode layer, a sixth lower electrode layer, and a sixth dielectric layer positioned between the sixth upper electrode layer and the sixth lower electrode layer; and a fifth via conductor penetrating the first capacitor, second capacitor, third capacitor, fourth capacitor, fifth capacitor, and sixth capacitor. The second via conductor may further be connected to the fifth lower electrode layer, the fourth via conductor may further be connected to the sixth lower electrode layer, and the fifth via conductor may be connected to the fifth upper electrode layer and sixth upper electrode layer. Thus, when a voltage is applied between the first and second via conductors, a voltage divided in three steps appears at the fifth via conductor.

A voltage dividing capacitor according to another aspect of the present disclosure includes: a first capacitor having a first upper electrode layer, a first lower electrode layer, and a first dielectric layer positioned between the first upper electrode layer and the first lower electrode layer; a second capacitor having a second upper electrode layer, a second lower electrode layer, and a second dielectric layer positioned between the second upper electrode layer and the second lower electrode layer; a third capacitor having a third upper electrode layer, a third lower electrode layer, and a third dielectric layer positioned between the third upper electrode layer and the third lower electrode layer; a first insulating resin layer positioned between the first lower electrode layer and the second upper electrode layer; a second insulating resin layer positioned between the second lower electrode layer and the third upper electrode layer; and first, second, third, and fourth via conductors penetrating the first capacitor, the first insulating resin layer, the second capacitor, the second insulating resin layer, and the third capacitor, wherein the first via conductor is connected to the first upper electrode layer, the second via conductor is connected to the third lower electrode layer, the third via conductor is connected to the second lower electrode layer and third upper electrode layer, and the fourth via conductor is connected to the first lower electrode layer and second upper electrode layer. Thus, when a voltage is applied between the first and second via conductors, a voltage divided more significantly appears at the third via conductor.

The above voltage dividing capacitor may further include a third insulating resin layer that covers the first upper electrode layer of the first capacitor, a first terminal electrode connected to the first via conductor, a second terminal electrode connected to the second via conductor, and a third terminal electrode connected to the third via conductor. The first, second, and third terminal electrodes may be provided on the third insulating resin layer. This allows the supply of an input voltage and a ground potential and take-out of an output voltage from the same surface of the voltage dividing capacitor.

The above voltage dividing capacitor may further include a fourth insulating resin layer that covers the third lower electrode layer of the third capacitor and a fourth terminal electrode provided on the fourth insulating resin layer and connected to the second via conductor. This can enhance heat dissipation.

A voltage dividing capacitor according to still another aspect of the present disclosure includes: a first capacitor having a first upper electrode layer, a first lower electrode layer, and a first dielectric layer positioned between the first upper electrode layer and the first lower electrode layer; a second capacitor having a second upper electrode layer, a second lower electrode layer, and a second dielectric layer positioned between the second upper electrode layer and the second lower electrode layer; a third capacitor having a third upper electrode layer, a third lower electrode layer, and a third dielectric layer positioned between the third upper electrode layer and the third lower electrode layer; a fourth capacitor having a fourth upper electrode layer, a fourth lower electrode layer, and a fourth dielectric layer positioned between the fourth upper electrode layer and the fourth lower electrode layer; a fifth capacitor having a fifth upper electrode layer, a fifth lower electrode layer, and a fifth dielectric layer positioned between the fifth upper electrode layer and the fifth lower electrode layer; a sixth capacitor having a sixth upper electrode layer, a sixth lower electrode layer, and a sixth dielectric layer positioned between the sixth upper electrode layer and the sixth lower electrode layer; a first insulating resin layer positioned between the first lower electrode layer and the second upper electrode layer; a second insulating resin layer positioned between the second lower electrode layer and the third upper electrode layer; a third insulating resin layer positioned between the third lower electrode layer and the fourth upper electrode layer; a fourth insulating resin layer positioned between the fourth lower electrode layer and the fifth upper electrode layer; a fifth insulating resin layer positioned between the fifth lower electrode layer and the sixth upper electrode layer; and first, second, third, fourth, fifth, and sixth via conductors penetrating the first capacitor, the first insulating resin layer, the second capacitor, the second insulating resin layer, the third capacitor, the third insulating resin layer, the fourth capacitor, the fourth insulating resin layer, the fifth capacitor, the fifth insulating resin layer, and the sixth capacitor, wherein the first via conductor is connected to the first upper electrode layer, the second via conductor is connected to the fifth lower electrode layer and sixth upper electrode layer, the third via conductor is connected to the fourth lower electrode layer and fifth upper electrode layer, the fourth via conductor is connected to the first lower electrode layer and second upper electrode layer, the fifth via conductor is connected to the second lower electrode layer, third upper electrode layer, and sixth lower electrode layer, and the sixth via conductor is connected to the third lower electrode layer and fourth upper electrode layer. Thus, when a voltage is applied between the first and second via conductors, a voltage divided still more significantly appears at the third via conductor.

The above voltage dividing capacitor may further include a sixth insulating resin layer that covers the first upper electrode layer of the first capacitor, a first terminal electrode connected to the first via conductor, a second terminal electrode connected to the second via conductor, and a third terminal electrode connected to the third via conductor. The first, second, and third terminal electrodes may be provided on the sixth insulating resin layer. This allows the supply of an input voltage and a ground potential and take-out of an output voltage from the same surface of the voltage dividing capacitor.

The above voltage dividing capacitor may further include a seventh insulating resin layer that covers the sixth lower electrode layer of the sixth capacitor and a fourth terminal electrode provided on the seventh insulating resin layer and connected to the second via conductor. This can enhance heat dissipation.

### REFERENCE SIGNS LIST

11 power supply circuit
12 Input Capacitor
100-103, 200, 300, 400, 500 voltage dividing capacitor
110, 120, 210, 220, 230, 240, 310, 320, 330, 340, 350, 360, 410, 420, 430, 510, 520, 530, 540, 550, 560 capacitor
111, 121, 211, 221, 231, 241, 311, 321, 331, 341, 351, 361, 411, 421, 431, 511, 521, 531, 541, 551, 561 upper electrode layer
112, 122, 212, 222, 232, 242, 312, 322, 332, 342, 352, 362, 412, 422, 432, 512, 522, 532, 542, 552, 562 lower electrode layer
113, 123, 213, 223, 233, 243, 313, 323, 333, 343, 353, 363, 413, 423, 433, 513, 523, 533, 543, 553, 563 dielectric film
111A, 111C, 112A, 112B, 121A, 121B, 122B, 122C, 211A, 211C, 211D, 212A, 212B, 212D, 221A, 221B, 221D, 222B, 222C, 222D, 231B, 231C, 231D, 232A, 232B, 232C, 241A, 241B, 241C, 242A, 242B, 242D slit
111V, 112V, 121V, 122V region
131-133, 251-255, 371-377, 441-444, 571-577 insulating resin layer
141-144, 261-264, 381-384, 451-454, 581-584 terminal electrode
LA, LA1-LA3, LB, LC1-LC3, LD1-LD3, LE1, LE2, LF1, LF2 electrode layer
VA-VF via conductor

1. A voltage dividing capacitor comprising:
a first capacitor having a first upper electrode layer, a first lower electrode layer, and a first dielectric layer positioned between the first upper electrode layer and the first lower electrode layer;
a second capacitor having a second upper electrode layer, a second lower electrode layer, and a second dielectric layer positioned between the second upper electrode layer and the second lower electrode layer;
a first insulating resin layer positioned between the first lower electrode layer and the second upper electrode layer; and
first, second, and third via conductors penetrating the first capacitor, the first insulating resin layer and the second capacitor,
wherein the first via conductor is connected to the first upper electrode layer,
wherein the second via conductor is connected to the second lower electrode layer, and
wherein the third via conductor is connected to the first lower electrode layer and second upper electrode layer.

2. The voltage dividing capacitor as claimed in claim 1, further comprising:
a first terminal electrode connected to the first via conductor; and
a second terminal electrode connected to the second via conductor.

3. The voltage dividing capacitor as claimed in claim 2, further comprising a second insulating resin layer that covers the first upper electrode layer of the first capacitor,
wherein the first and second terminal electrodes are provided on the second insulating resin layer.

4. The voltage dividing capacitor as claimed in claim 3, further comprising a third terminal electrode connected to the third via conductor,
wherein the third terminal electrode is provided on the second insulating resin layer.

5. The voltage dividing capacitor as claimed in claim 3, further comprising:
a third insulating resin layer that covers the second lower electrode layer of the second capacitor; and
a fourth terminal electrode provided on the third insulating resin layer and connected to the second via conductor.

6. The voltage dividing capacitor as claimed in claim 3, further comprising:
a third capacitor having a third upper electrode layer, a third lower electrode layer, and a third dielectric layer positioned between the third upper electrode layer and the third lower electrode layer;
a fourth capacitor having a fourth upper electrode layer, a fourth lower electrode layer, and a fourth dielectric layer positioned between the fourth upper electrode layer and the fourth lower electrode layer;
a third insulating resin layer positioned between the second lower electrode layer and the third upper electrode layer;
a fourth insulating resin layer positioned between the third lower electrode layer and the fourth upper electrode layer; and
a fourth via conductor penetrating the first capacitor, second capacitor, third capacitor, and fourth capacitor,
wherein the second via conductor is further connected to the third upper electrode layer,
wherein the third via conductor is further connected to the fourth lower electrode layer, and
wherein the fourth via conductor is connected to the third lower electrode layer and the fourth upper electrode layer.

7. The voltage dividing capacitor as claimed in claim 6, further comprising a third terminal electrode connected to the fourth via conductor,
wherein the third terminal electrode is provided on the second insulating resin layer.

8. The voltage dividing capacitor as claimed in claim 7, wherein one end of the third via conductor is embedded in the second insulating resin layer without being exposed therefrom.

9. The voltage dividing capacitor as claimed in claim further comprising:
a fifth capacitor having a fifth upper electrode layer, a fifth lower electrode layer, and a fifth dielectric layer positioned between the fifth upper electrode layer and the fifth lower electrode layer;
a sixth capacitor having a sixth upper electrode layer, a sixth lower electrode layer, and a sixth dielectric layer positioned between the sixth upper electrode layer and the sixth lower electrode layer; and
a fifth via conductor penetrating the first capacitor, second capacitor, third capacitor, fourth capacitor, fifth capacitor, and sixth capacitor,
wherein the second via conductor is further connected to the fifth lower electrode layer,
wherein the fourth via conductor is further connected to the sixth lower electrode layer, and
wherein the fifth via conductor is connected to the fifth upper electrode layer and the sixth upper electrode layer.

10. A voltage dividing capacitor comprising:
a first capacitor having a first upper electrode layer, a first lower electrode layer, and a first dielectric layer positioned between the first upper electrode layer and the first lower electrode layer;
a second capacitor having a second upper electrode layer, a second lower electrode layer, and a second dielectric layer positioned between the second upper electrode layer and the second lower electrode layer;
a third capacitor having a third upper electrode layer, a third lower electrode layer, and a third dielectric layer positioned between the third upper electrode layer and the third lower electrode layer;
a first insulating resin layer positioned between the first lower electrode layer and the second upper electrode layer;
a second insulating resin layer positioned between the second lower electrode layer and the third upper electrode layer; and
first, second, third, and fourth via conductors penetrating the first capacitor, the first insulating resin layer, the second capacitor, the second insulating resin layer, and the third capacitor,
wherein the first via conductor is connected to the first upper electrode layer,
wherein the second via conductor is connected to the third lower electrode layer,
wherein the third via conductor is connected to the second lower electrode layer and the third upper electrode layer, and
wherein the fourth via conductor is connected to the first lower electrode layer and the second upper electrode layer.

11. The voltage dividing capacitor as claimed in claim 10, further comprising:
a third insulating resin layer that covers the first upper electrode layer of the first capacitor;
a first terminal electrode connected to the first via conductor;
a second terminal electrode connected to the second via conductor; and
a third terminal electrode connected to the third via conductor,
wherein the first, second, and third terminal electrodes are provided on the third insulating resin layer.

12. The voltage dividing capacitor as claimed in claim 10, further comprising:
a fourth insulating resin layer that covers the third lower electrode layer of the third capacitor; and
a fourth terminal electrode provided on the fourth insulating resin layer and connected to the second via conductor.

13. A voltage dividing capacitor comprising:
a first capacitor having a first upper electrode layer, a first lower electrode layer, and a first dielectric layer positioned between the first upper electrode layer and the first lower electrode layer;
a second capacitor having a second upper electrode layer, a second lower electrode layer, and a second dielectric layer positioned between the second upper electrode layer and the second lower electrode layer;
a third capacitor having a third upper electrode layer, a third lower electrode layer, and a third dielectric layer positioned between the third upper electrode layer and the third lower electrode layer;
a fourth capacitor having a fourth upper electrode layer, a fourth lower electrode layer, and a fourth dielectric layer positioned between the fourth upper electrode layer and the fourth lower electrode layer;
a fifth capacitor having a fifth upper electrode layer, a fifth lower electrode layer, and a fifth dielectric layer positioned between the fifth upper electrode layer and the fifth lower electrode layer;
a sixth capacitor having a sixth upper electrode layer, a sixth lower electrode layer, and a sixth dielectric layer positioned between the sixth upper electrode layer and the sixth lower electrode layer;
a first insulating resin layer positioned between the first lower electrode layer and the second upper electrode layer;
a second insulating resin layer positioned between the second lower electrode layer and the third upper electrode layer;
a third insulating resin layer positioned between the third lower electrode layer and the fourth upper electrode layer;
a fourth insulating resin layer positioned between the fourth lower electrode layer and the fifth upper electrode layer;
a fifth insulating resin layer positioned between the fifth lower electrode layer and the sixth upper electrode layer; and
first, second, third, fourth, fifth, and sixth via conductors penetrating the first capacitor, the first insulating resin layer, the second capacitor, the second insulating resin layer, the third capacitor, the third insulating resin layer, the fourth capacitor, the fourth insulating resin layer, the fifth capacitor, the fifth insulating resin layer, and the sixth capacitor,
wherein the first via conductor is connected to the first upper electrode layer,
wherein the second via conductor is connected to the fifth lower electrode layer and the sixth upper electrode layer,
wherein the third via conductor is connected to the fourth lower electrode layer and the fifth upper electrode layer,
wherein the fourth via conductor is connected to the first lower electrode layer and the second upper electrode layer,
wherein the fifth via conductor is connected to the second lower electrode layer, the third upper electrode layer, and the sixth lower electrode layer, and
wherein the sixth via conductor is connected to the third lower electrode layer and the fourth upper electrode layer.

14. The voltage dividing capacitor as claimed in claim 13, further comprising:
a sixth insulating resin layer that covers the first upper electrode layer of the first capacitor;
a first terminal electrode connected to the first via conductor;
a second terminal electrode connected to the second via conductor; and
a third terminal electrode connected to the third via conductor,
wherein the first, second, and third terminal electrodes are provided on the sixth insulating resin layer.

15. The voltage dividing capacitor as claimed in claim 13, further comprising:
a seventh insulating resin layer that covers the sixth lower electrode layer of the sixth capacitor; and
a fourth terminal electrode provided on the seventh insulating resin layer and connected to the second via conductor.
